(19) United States
(12) Patent Application Publication
(10) Pub. No.: US 2011/0159167 A1
(43) Pub. Date: Jun. 30, 2011

(54) METHOD FOR ISOLATING OILS FROM CELLS AND BIOMASSES

(76) Inventors: Matthias Ruesing, Koln (DE); Florian Enzenberger, Erlangen (DE); Lothar Ott, Visp (CH); Thomas Gruetzner, Brig (CH)

(21) Appl. No.: 13/054,315

(22) PCT Filed: Jul. 14, 2009
(86) PCT No.: PCT/EP2009/005112

§ 371 Date: Jan. 14, 2011

Related U.S. Application Data
(60) Provisional application No. 61/080,844, filed on Jul. 15, 2008.

(30) Foreign Application Priority Data
Jul. 15, 2008 (EP) 08012759.0

(51) Int. Cl. A23D 7/04; A23K 1/00; A23L 1/29; A23D 9/04

(52) U.S. Cl. 426/601

(57) ABSTRACT

The present invention relates to a process for the isolation of oils from cells, characterized in that the emulsion produced after the decomposition of the cells by high-pressure homogenization is demulsified. Any desired fatty acid compositions or oil compositions can be obtained in one simple step by mixing different biomasses and optionally adding further oils in an excess.

The present invention comprises a process for the isolation of oils and/or fats from cells and biomass as well as oils, fats and oil mixtures obtainable in accordance with this process.

Products biologically produced in cells must often be isolated in an expensive manner. It is necessary for this to decompose the cells. This can take place in various ways. Methods of cell maceration described in the state of the art are, e.g., chemical or biological treatment, the effect of osmotic pressure, freezing and thawing, ultrasound, freezing dispersion, pressing, wet grinding in agitator ball mills or high-pressure homogenization (S. Schultz et al., Hochdruckhomogenisation als ein Verfahren zur Emulsionsherstellung [German=High-Pressure Homogenization as a Process for Emulsion Production], Chem. Ing. Tech. 2002, 74 (7), 901-909).

In high-pressure homogenization the fluid to be macerated is pressed with a high pressure through a narrow slot. As a result of the low slot height a very high speed and a very low pressure are achieved in accordance with Bernoulli's law. The cell membrane is damaged on account of the suddenly building up of a high energy density, the pressure drop and the resulting cavitation.

The disadvantage of this process in that in addition to the desired maceration of the cell membranes it also results in an undesired stabilization of the emulsion being produced on account of the fine distribution of oil droplets in the continuous aqueous phase. In addition, the homogenized broth contains finely distributed cellular components, for which reason it is also called a suspo emulsion. The cellular components can additionally exert a stabilizing effect on the emulsion. Furthermore, an emulsion is stabilized by water-soluble salts of fatty acids or proteins, which are both to be expected in the fermentation broth.

The present invention therefore has the problem of making a process available that makes possible the isolation of oils, preferably oils containing polyunsaturated fatty acids (PUFAs), from cells or biomass in a higher yield and with better quality than with processes known from the state of the art.

This problem is solved by the process in accordance with the invention, that is characterized in that the suspo emulsion produced by high-pressure homogenization is demulsified.

The demulsification in accordance with the invention can take place mechanically, physically, (electro-)chemically or by any combination of these demulsification methods.

The mechanical demulsification preferably takes place by centrifugation, sedimentation, floatation, ultra-filtration with capillary membranes or other membranes.

The mechanical demulsification preferably takes place in a temperature range of 0-100° C.

The physical demulsification preferably takes place by means of physisorbtion or extraction of the obtained suspo emulsion with one or more linear, cyclic or aromatic hydrocarbons such as, e.g., propane, hexane cyclohexane or toluene.

Hexane is an especially preferred solvent.

The physical demulsification preferably takes place in a temperature range from 0-100° C.

The electrochemical demulsification preferably takes place by electrocoagulation or electrophoresis. The chemical demulsification preferably takes place by chemisorption, electrolyte addition or a surface-active auxiliary agent.

The chemical demulsification is preferably by means of a surfactant, especially preferably with a fatty alcohol ethoxylate, especially with triethylene glycolmonodecylether.

The surfactant in accordance with the invention is used in a concentration of up to 25 g/l, preferably 10-20 g/l and especially preferably 20 g/l.

The chemical demulsification preferably takes place in a temperature range of 0-100° C.

The invention furthermore comprises oils obtainable in accordance with the process of the invention. In a preferred embodiment these oils contain omega-3 and/or omega-6 fatty acids such as, e.g., docosahexaenoic acid (DHA), docosapentaenoic acid (DPA), eicosapentaenoic acid (E)A), alphalinolenic acid (ALA), arachidonic acid (ARA), gammalinolenic acid (GLA), dihomogammalinolenic acid (DHGLA), linolenic acid (LA), or mixtures of the cited fatty acids. Tab. 1 shows an example for a DHA-rich oil in accordance with the present invention. Mixtures of one or more of the cited omega-3 and/or omega-6 fatty acids with saturated or monounsaturated fatty acids form another preferred embodiment.

TABLE 1
Typical composition of the oil in accordance with the invention

| | | Average value |
|---|---|---|
| | | from double |
| | Abbre- | determination |
| Chemical name (English) | viation | GC surface % |
| Tetradecanoic acid | Myristin | 1.7 |
| Pentadecanoic acid | Pentadecan | 1.1 |
| Hexadecanoic acid | Paimitin | 24.7 |
| Heptadecanoic acid | Heptadecan | 0.4 |
| Octadecanoic acid | Stearin | 0.7 |
| All-cis-4,7,10,13-eicosatetraenoic acid | ETA (7) | 0.5 |
| All-cis-8,11,14,17-eicosatetraenoic acid | ETA (3) | 0.7 |
| All-cis-5,8,11,14,17-eicosapentaenoic acid | EPA | 0.1 |
| All-cis-4,7,10,13,16-docosapentaenoic acid | DPA (6) | 12.2 |
| All-cis-7,10,13,16,19-docosapentaenoic acid | DPA (3) | 0.4 |
| All-cis-4,7,10,13,16,19-docosahexaenoic acid | DHA | 53.2 |
| Andere | Andere | 3.5 |
| | | Mass % |
| All-cis-4,7,10,13,16,19-docosahexaenoic acid | DHA | 22.9 |

The oil obtainable with the process of the invention is characterized, in comparison to the oil produced by the processes known in the state of the art, by an especially high quality manifested in a peroxide number of <5 meq/kg and an anisidine value of <30.

According to the invention, microorganisms can be used that are suitable for obtaining PUFA. These microorganisms are found, for example, in the bacteria in the genus Vibrio (e.g.: Vibrio marinus) or among the dinoflagellates (Dinophyta) in particular the genus Crypthecodinium such as C. cohnii or among the Stramenopiles such as the Pinguiophyceae such as, e.g., Gloseeomastix, Phaeomonas, Pinguiochrysis, Pinguiococcus and Polydochrysis. Preferred microorganisms for the fermentative production of PUFA belong to the Stramenopiles (or Labyrinthulomycota) especially to the order Thraustochytriales, (Thraustchytriidea) and there again in particular to the genera Japonochytrium, Schizochytrium, Thraustochytrium, Althornia, Labyrinthuloides, Aplanochytrium and Ulkenia, as well as Zygomycetes such as Mortierella alpina, Mortierella elongata or other species, Pythium insidiosum, Pythium irregulare or other species.

Almost all desired specific oil spectra or fatty-acid spectra can be obtained by mixing two or more different oil-containing biomasses in any ratios by a skillful selection of the biomasses or of the appropriate oil compositions of the biomasses. E.g., mixtures of omega-3 DHA-containing and omega-6 arachidonic acid (ARA)-containing biomass, e.g., of Ulkenia spec. and Mortierella alpina if necessary with the addition of further oil-containing biomasses, are preferred.

In a further embodiment biomass or cellular material can be jointly extracted from one or more sources with the addition of further oils. Also, many desired oil compositions can be obtained in one step by the selection of the biomass(es) and of the further oils, as well as of the ratios used.

In a preferred embodiment biomasses or cells with a high PUFA content are extracted with the addition of an excess of oils with a lower PUFA content, as a result of which a stabilization (protection from oxidation) of the PUFA occurs. Suitable oils are in particular vegetable oils such as sunflower oil, olive oil, palm oil, bristle thistle oil, borage oil, evening primrose oil, corn oil, soy oil, linseed oil, rape-seed oil, but also animal oils such as fish oil, krill oil, etc., as well as fractionated oils on this basis, as well as, in addition, any oil mixtures.

In an especially preferred form the extraction is made with an excess of palm olein. Palm olein (fractionated palm oil) contains a mixture of PUFA, monounsaturated and saturated fatty acids. The relative composition is approximately 44% oleic acid, 10% linoleic acid, 40% palmitic acid and 5% stearic acid. In a quite especially preferred form DHA and ARA-containing biomass is extracted in a ratio of 5:1 to 1:5 (relative to ARA and DHA content) with up to twenty times an excess of vegetable or animal oils such as sunflower oil, olive oil, palmolein oil, fish oil, etc.

The invention is explained by the following non-limiting examples.

### EXAMPLE 1

Aqueous fermentation broth Ulkenia sp. Strain SAM2179 is continuously supplied to a high-pressure homogenizer (e.g., APV 2000). The high-pressure homogenization can take place in one or two stages, whereby the pressure of the last stage is selected to be so high that the predominant part of the algae cells is macerated. The pressure of the high-pressure homogenizer necessary for the above fermentation broth for the quantitative maceration of the cells was at least 60 MPa. The suspo emulsion produced can now be demulsified by
a) mechanical,
b) physical,
c) chemical
   methods, i.e. a release of the PUFA-containing oil can be achieved.
a) E.g., Centrifugation can be considered as mechanical demulsification. 50 mL of the high-pressure homogenized aqueous microalgae suspension yields, after 24 hours agitation at 60° C. and subsequent centrifugation for 10 minutes at 3300 revolutions per minute, 0.74 g oil, corresponding to an oil yield of 62% (whereby the DHA component was 20.2% by weight.
b) 500 g of the high-pressure homogenized suspo emulsion were shaken out with 200 mm hexane at room temperature and subsequently this solution was centrifuged for 10 minutes at 3300 revolutions per minute and the hexane phase obtained in this manner separated. The remaining aqueous phase was extracted two times more with 200 mm hexane each time and centrifuged. After the combining of the organic phases and evaporating off the hexane at 200 mbar and 40° C. on a rotary evaporator 13.8 g oil remained, corresponding to an oil yield of 92% (of which the DHA component was 33.1% by weight).
c) 50 mL of the high-pressure homogenized aqueous microalgae suspension were agitated with 0.75 g of the fatty alcohol ethoxylate dehydol D3 for six hours at room temperature. This solution was subsequently centrifuged for 10 minutes at 3300 revolutions per minute and 1.14 g oil was obtained in this manner, corresponding to an oil yield of 95% (of which the DHA component was 33.3% by weight).

### EXAMPLE 2

Aqueous fermentation broth with DHA-containing Ulkenia (strain SAM2179) biomass (oil content approximately 50%, DHA content in the oil approximately 44%) was continuously supplied with ARA-containing biomass (Mortierella alpina, oil content approximately 55%, ARA content in the oil approximately 40%) in a ratio of 1:1 (relative to the dry weight content of the biomass) to a high-pressure homogenizer (e.g., APV 2000). The high-pressure homogenization can take place here in one or two stages, whereby the pressure of the last stage is selected to be so high that the predominant part of the cells is macerated. The pressure of the high-pressure homogenizer necessary for the above fermentation broth for the quantitative maceration of the cells was at least 60 MPa. The suspo emulsion produced can now be demulsified by mechanical, physical, or chemical methods, and in this manner a release of the PUFA-containing oil can be achieved.

50 mL of the high-pressure homogenized aqueous suspension were agitated with 0.75 g of the fatty alcohol ethoxylate dehydol D3 for six hours at room temperature. This solution was subsequently centrifuged for 10 minutes at 3300 revolutions per minute and approximately 1 g oil was obtained in this manner, corresponding to an oil yield of approximately 90-95% and to a ratio of DNA to ARA of approximately 1:1.

### EXAMPLE 3

Aqueous fermentation broth with DHA-containing Ulkenia (strain SAM2179) biomass was continuously supplied under the addition of sunflower oil in an excess to a high-pressure homogenizer (e.g., APV 2000). The following mixing ratio was selected:
i) fermentation broth from DHA-containing Ulkenia biomass (5.5 liters, corresponding to approximately 335 g dry biomass, oil content approximately 50%, DNA content in the oil approximately 50%)
ii) 0.095 kg sunflower oil.

The high-pressure homogenization took place according to ex. 2.

50 mL of the high-pressure homogenized aqueous suspension were agitated with 0.75 g of the fatty alcohol ethoxylate dehydol D3 for six hours at room temperature. This solution was subsequently centrifuged for 10 minutes at 3300 revolutions per minute and approximately 2.3 g oil were obtained in this manner, corresponding to an oil yield of approximately 95% and to a DHA content of 32%.

### EXAMPLE 4

Extraction from ARA-containing biomass under the addition of fish oil (DHA content (25%) and palmitolein oil in an excess by high-pressure homogenizer (e.g., APV 2000). The following mixing ratio was selected:
i) ARA-containing Mortierella alpina biomass (corresponding to approximately 225 g dry biomass, oil content approximately 55%, ARA-content in the oil approximately 40%)
ii) 0.3 kg palmitolein oil.
iii) 0.2 kg fish oil (DHA 25%).

The high-pressure homogenization took place according to ex. 2.

50 mL of the high-pressure homogenized aqueous suspension were agitated with 0.75 g of the fatty alcohol ethoxylate dehydol D3 for six hours at room temperature. This solution was subsequently centrifuged for 10 minutes at 3300 revolutions per minute and approximately 5 g oil were obtained in this manner, corresponding to an oil yield of approximately 95% and to an ARA content of approximately 8% and to a DHA content of approximately 8%.

### EXAMPLE 5

Aqueous fermentation broth with DHA-containing Ulkenia (strain SAM2179) biomass (oil content approximately 50%, DHA content in the oil approximately 44%) was continuously supplied in an excess with ARA-containing biomass (Mortierella alpina, oil content approximately 55%, ARA content in the oil approximately 40%) in a ratio of 1:2 (relative to dry biomass) to a high-pressure homogenizer (e.g., APV 2000) under the addition of palmolein. The following mixing ratio was selected:
i) fermentation broth of DHA-containing Ulkenia biomass (5.5 liters, corresponding to approximately 335 g dry biomass, oil content approximately 50%, DHA content in the oil approximately 44%)
ii) ARA-containing Mortierella alpina biomass (corresponding to approximately 665 g dry biomass, oil content approximately 55%, ARA-content in the oil approximately 40%)
iii) 1.3 kg palmolein oil.

The high-pressure homogenization took place according to ex. 2.

50 mL of the high-pressure homogenized aqueous suspension were agitated with 0.75 g of the fatty alcohol ethoxylate dehydol D3 for six hours at room temperature. This solution was subsequently centrifuged for 10 minutes at 3300 revolutions per minute and approximately 5 g oil were obtained in this manner, corresponding to an oil yield of approximately 95% and to a ratio of DHA to ARA of approximately 1:2.

1. A process for the isolation of an oil from cells and/or biomass characterized in that the emulsion produced after the decomposition of the cells by high-pressure homogenization is demulsified.

2. The process according to claim 1, in which the demulsification takes place chemically.

3. The process according to claim 2, in which the demulsification takes place by a surfactant.

4. The process according to claim 3, in which the surfactant is a fatty alcohol ethoxylate.

5. The process according to claim 4, in which the surfactant is triethylene glycolmonodecylether.

6. The process according to at least one of claims 3-5, in which the surfactant is used in a concentration of up to 25 g/l, preferably 10-20 g/l and especially preferably 20 g/l.

7. The process according to at least one of claims 1-6, in which the demulsification takes place at a temperature of 0-100° C.

8. The process according to claim 1, in which the demulsification takes place mechanically.

9. The process according to claim 8, in which the demulsification takes place by a centrifuge.

10. The process according to claims 8 and/or 9, in which the demulsification takes place at a temperature of 0-100° C.

11. The process according to claim 1, in which the demulsification takes place physically.

12. The process according to claim 11, in which the demulsification takes place by extraction of the suspo emulsion with one or more linear, cyclic or aromatic hydrocarbons.

13. The process according to claim 12, in which the solvent is a hexane.

14. The process according to at least one of claims 11-13, in which the demulsification takes place at a temperature of 0-100° C.

15. The process according to at least one of claims 1-14, in which the omega-3 PUFA-producing microorganisms are used that belong to the group of thraustochytriales, such as, e.g., strains of Ulkenia, Thraustochytrium and/or Schizochytrium and/or omega-6 producing microorganisms such as Mortierella or Pythium.

16. The process according to at least one of claims 1-15, in which at least one further oil and/or at least one further oil-containing biomass is/are added to the cells or to the biomass before the high-pressure homogenization.

17. The process according to claim 16, in which oils with a rather low PUFA concentration are concerned.

18. The process according to claim 17, in which vegetable oils, animal oils and/or fractionated oils are concerned.

19. The process according to claim 18, in which the oils are selected from the group consisting of sunflower oil, olive oil, palm oil, bristle thistle oil, borage oil, evening primrose oil, corn oil, soy oil, linseed oil, rape-seed oil, fish oil and/or krill oil.

20. The process according to claim 18, in which fractionated palm oil is concerned.

21. The process according to claim 16, in which a DHA-containing biomass and an ARA-containing biomass in a ratio of 5:1 to 1:5 are concerned.

22. The oil obtainable according to a process in accordance with at least one of claims 1-21.

23. The oil according to claim 22, containing docosahexaenoic acid (DHA) and/or docosapentaenoic acid (DPA).

24. The oil according to claim 23, in which the oil has a peroxide number of <5 meq/kg and an anisidine value of <30.

25. A mixture of at least 2 cell types and/or biomasses for use in a process according to at least one of claims 1-21.

26. The mixture according to claim 25, containing at least one further oil.

27. The mixture according to claim 26, in which the oil is vegetable oils, animal oils and/or fractionated oils.

28. The mixture according to claim 27, in which the oil is sunflower oil, olive oil, palm oil, bristle thistle oil, borage oil, evening primrose oil, corn oil, soy oil, linseed oil, rape-seed oil, fish oil and/or krill oil.

29. The use of the oil according to at least one of claims 22-24 as an additive for food, food supplements, animal fodder.

30. The use according to claim 29, in which special food products are concerned, such as, e.g., baby milk, baby food, medicinal food products, diet products as well as products according to PARNUTS (foods for particular nutritional uses).
